(19) United States
(12) Patent Application Publication
(10) Pub. No.: US 2013/0188060 A1
(43) Pub. Date: Jul. 25, 2013

(54) Method, System and Apparatus for Testing Video Quality

(71) Applicants: Victor Steinberg, Santa Clara, CA (US); Michael Shinsky, Santa Clara, CA (US)

(72) Inventors: Victor Steinberg, Santa Clara, CA (US); Michael Shinsky, Santa Clara, CA (US)

(21) Appl. No.: 13/356,327

(22) Filed: Jan. 23, 2012

(51) Int. Cl. H04N 17/02; H04N 17/00

(52) U.S. Cl. 348/182; 348/181; 348/E17.004

(57) ABSTRACT

Systems and methods are disclosed for testing video quality by generating a stress tracker test pattern with one or more moving zone plates and one or more stamps; determining compression quality scores for encoder resources spent at predetermined levels of compression (stress); and analyzing the test pattern and generating a Compression Stress Response profile.

### BACKGROUND

The present invention relates to a video content processing and content delivery systems.

Many applications require quality evaluation of video images. Such evaluations can be subjective or objective. Subjective quality evaluation techniques for video images are fully specified in the ITU-T Recommendation BT.500. The Recommendation provides a methodology for numerical indication of the perceived quality from the users' perspective of received media after compression and/or transmission.

The score is typically expressed as a single number in the range 1 to 5, where 1 is lowest perceived quality, and 5 is the highest perceived.

Currently there are two main types of objective video degradation measurement processes:

1. Full reference methods (FR), where the whole original video signal is available

2. No-reference methods (NR), where the original video is not available at all

Devices and processes of both types can be used in off-line systems (file-based environment) as well as in on-line systems (live video transmission).

Video content re-purposing and delivery system Quality Control (QC) should be fully automatic because checking thousands of channels and hundreds of formats semi-automatically is not an economically viable option.

The most widely used FR video quality metric during the last 20 years is Peak Signal-to-Noise Ratio (PSNR). PSNR is used approximately in 99% of scientific papers, but only in 20% of marketing materials.

The validity of PSNR metric is limited and often disputed. This also applies to all PSNR derivatives, such as Structural similarity (SSim) and many others.

Significant drawback of all PSNR-based tools is that they require perfect spatial, temporal and color space alignment of two pictures A and B used for comparison:
A=Original picture, presumed to be of very good (pristine) quality,
B=Output picture, typically distorted by video processor of some sort Common examples of the video processor under test are:
Video scalers and format converters, including color space converters
Compression codecs, such as MPEG2, H264, etc.

Certain software tools, such as ClearView A/V Analyzers by US-based Video Clarity, allow playout, capture and direct visualization of A-B pictures and further calculation of PSNR values or more sophisticated error metrics.

http://www.videoclarity.com/CVSoftwareOM.html, http://www.videoclarity.com/PDF/ClearViewDataSheet.pdf

However, in case of even small A vs. B discrepancies in frame sizes, color spaces, time-line positions, etc., these tools are in fact not applicable—because the total contribution of these “secondary” factors to the integral sum(abs(A-B)) error is typically much larger then the strength of the artefacts to be measured.

All attempts to automatically estimate these discrepancies and automatically compensate their effect (i.e. auto-equalize A with B) have been rather unsuccessful.

On the other hand, there are well-known objective techniques, such as time-code insertion for time-line position reading, and automatic measurement of video processor parameters based on artificial test patterns.

However, these techniques have been so far not used in compression artefacts measurements tools available on the market—mainly because of the out-dated assumption that the purpose of video compression codec is to produce output picture as close as possible to the primary reference, i.e. to the original picture—byte by byte, dot by dot.

In fact, modern multi-format content delivery system processes original high quality content (i.e. primary reference, typically coming from a single source) and delivers it as a set of streamed or downloaded pictures in a variety of frame sizes, aspect ratios, frame rates and even color spaces.

In such system the set of output (delivered) images should look on the screens of the appropriate players as close as possible to a set of best available secondary references, i.e. to optimally converted versions of the original picture presented in a variety of formats.

FIG. 1 illustrates a prior art video compression quality measurement system block diagram. It should be noted that prior art systems typically use external sources of test materials and/or test patterns and external devices to measure the quality loss due to the encoding of video content.

Referring initially to FIG. 1, input video content package typically contains descriptive metadata 102 as well as main video content data 104—typically in uncompressed format.

In test mode this input video is replaced by the test stream 106, which may represent static or dynamic test pattern, or even short video clip—so called “reference video”.

Via input selector 108 input video data 110 are fed to the compression encoder 112, controlled by Media Assets Management System 114 and/or Operator (Compressionist), providing coding preset 116 based among other factors on the incoming metadata 102.

Encoder 112 outputs compressed video stream 118 going to the Content Delivery Network 120.

Reference decoder 122 converts compressed stream 118 to the decompressed data 124, thus allowing calculation of differential (“A-B”) video stream 128 in the block 126.

Stream 128, which represents compression artefacts (errors), goes into the block 130, which calculates compression quality estimate (quality score) in accordance to some commonly accepted algorithm (metric).

The result is Quality Report 132 document (set of compression quality scores).

Major drawback of such architecture is its incapacity to handle any modification of picture parameters except the compression itself.

Another well-known vulnerability of all existing compression quality measurement systems is a lack of commonly accepted test sequences suitable for modern multi-format Content Delivery Networks.

Popular video test materials, such as live clips, are usually adequate only for some specific applications and cover only small range of frame sizes and bitrates.

Thus, fundamentally different Video Quality Control technologies are needed.

Scientific approach should be based on the development of artificial, repeatable and scalable “Compression Stress Tracker” test pattern covering much wider range of video formats.

In any case, reliable information about global spatial, temporal, and color space parameters of the delivered video must be available prior to actual compression artefacts assessment.

For this purpose some video QC systems use descriptive technical metadata, but they are prone to human mistakes and often missing.

The most reliable way to provide the necessary information about the delivered video consists in the automated measurement of pre-inserted reference markers or “stamps”.

For correct operation of the video quality analyzer it is highly desirable to have such stamps in the incoming video and use them as a “helper” for accurate compression artefacts measurements.

### SUMMARY

Systems and methods are disclosed for testing video quality by generating a stress tracker test pattern with one or more moving zone plates and one or more stamps; determining compression quality scores for encoder resources spent at predetermined levels of compression (stress); and analyzing the test pattern and generating a Compression Stress Response profile.

In one aspect, a system to perform automated analysis of video quality of a video processor or complete content delivery system, encompassing among others blocks video scalers, encoders, transcoders and decoders/players, and including (1) “clean zone” insertion means, which put into video images at least one area of pre-defined size and position, consisting of pre-defined static or dynamic test pattern, thus creating first component of primary reference video sequence, (2) “compression stress zone” insertion means, which put into original primary reference video images at least one area of pre-defined size and position, consisting of pseudo-random textures, the textures luminance and chrominance contrast and/or texture size varying along the time-line in accordance with the pre-defined set of stress levels, thus creating second component of primary reference video sequence; together said components form complete compression stress test sequence.

In another aspect, a system to perform automated analysis of video quality of a video processor or complete content delivery system, encompassing among others blocks video scalers, encoders, transcoders and decoders/players, and including (1) “reference stamps” insertion means, which put into original, typically uncompressed, video images a set of pre-defined area stamps, including predefined content code (clip number) stamp, time-code stamps, spatial position (geometry) stamps, and color space stamps, thus creating primary reference video sequence, (2) means for automatic input video format detection and conversion of delivered video data into uncompressed format, (3) means for automatic measurements of parameters of all stamps contained within the delivered images, (4) means for creation or retrieval of secondary reference video sequence matching delivered video images in size, spatial position, aspect ratio, time-line position and color space, (5) means for error image calculation providing a difference between delivered video sequence and secondary reference sequence, (6) means for conversion of the said differential images into objective statistical values, which calculate these values separately for stress zone and clean zone, and separately for each stress level, thus creating measured stress response time profile, (7) means for conversion of said objective statistical values into reported objective score values correlated with traditional subjective image quality scores.

Main video, underlying reference stamps, could be a stress test sequence, or another artificial test pattern, or any live clip, or any combination of these types suitable for particular video quality testing task.

The system can be used for a plethora of video quality tests, e.g. for benchmarking of scalers and/or compression codecs.

Moreover, in one embodiment where the video processors are based on multi-thread parallel calculation schemes, the processing of the short stamped reference test stream may happen simultaneously with the main (unstamped) video content processing.

And all parallel threads can be controlled by the same settings; thus the impairments of main video stream, e.g. color space errors or compression distortions, can be assessed by objective measurement of the corresponding impairments of the accompanying test stream.

### BRIEF DESCRIPTION OF THE DRAWINGS

Embodiments of the invention described herein will become apparent from the following detailed description considered in connection with the accompanying drawings, which disclose several embodiments of the invention. It should be understood, however, that the drawings are designed for the purpose of illustration and not as limits of the invention.

FIG. 1 illustrates a prior art video quality measurement system block diagram.

FIG. 2 shows an exemplary Stress Tracker Test Pattern with Moving Zone Plate and Stamps.

FIG. 3 shows exemplary snapshots of “Golfer” live clip with Stamps.

FIG. 4 shows an exemplary Stress Tracker test sequence timeline.

FIG. 5 shows an exemplary variant of Stress Tracker Test with static picture in the Clean Zone.

FIG. 6 shows one embodiment of a Video Compression Quality Meter system block diagram.

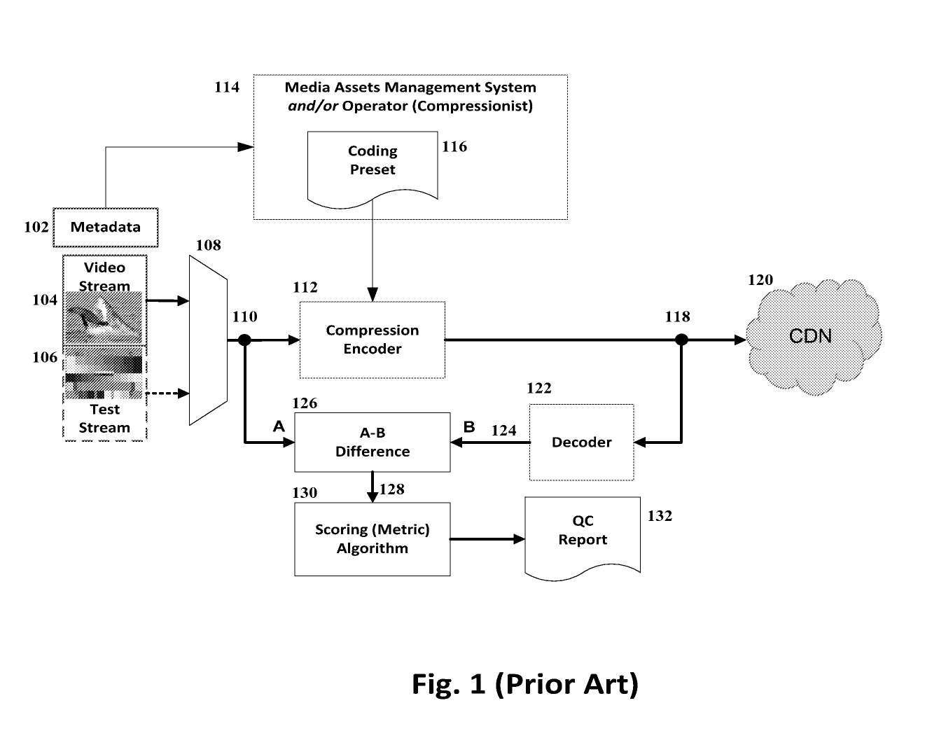

### DETAILED DESCRIPTION

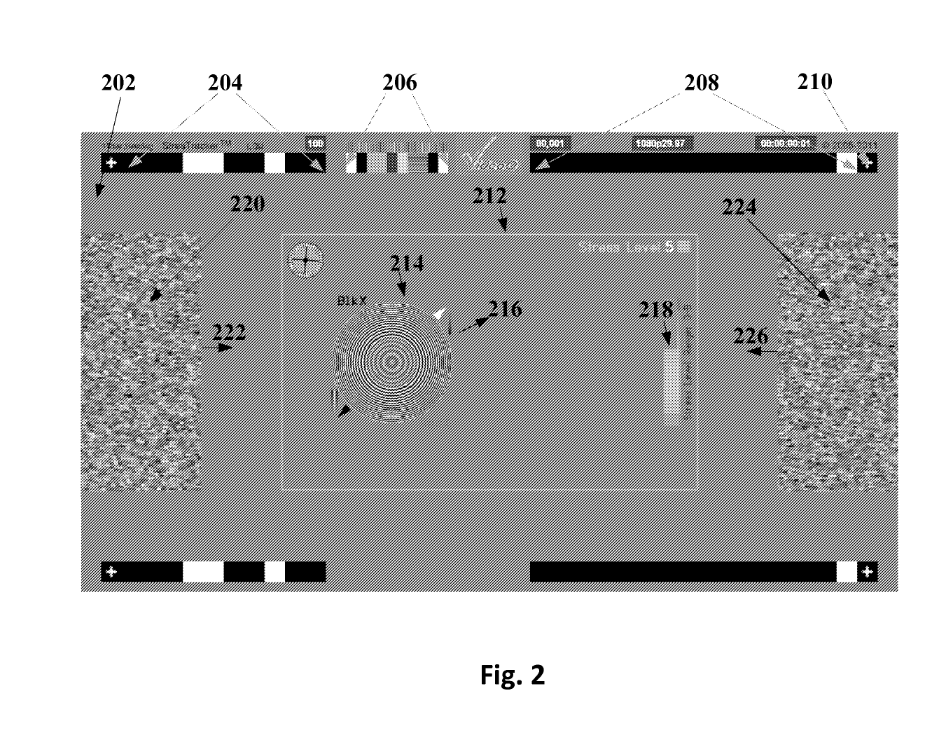

FIG. 2 shows example of Stress Tracker Test Pattern with Moving Zone Plate and Stamps.

This test pattern allows calculation of compression quality scores for several levels of “stress”, which means here the amount of compression encoder resources spent.

In combination with the appropriate meter/analyzer this test pattern allows building of

Compression Stress Response Profile. Such profiles are critical for benchmarking, acceptance tests and comparison of various encoding presets.

In the example shown the test pattern consists of flat gray background 202, one Clean Zone, two Stress Zones and two sets of Reference Stamps. For better noise immunity all stamps of the set are repeated twice—at the top and bottom of the image.

Pattern Code Stamp 204 represents in binary format (9 bit in this example) an ID code of the pattern used. This allows automatic recognition of the incoming video ID and automatic selection of the matching secondary reference data.

Color Reference Stamp 206 contains several shades of Gray and calibrated Green patch, plus digital burst of the highest possible frequency. These components provide for automatic detection and measurement of any color space modifications introduced by video data processing within the Content Delivery Network.

Frame Number Stamp 208 (16 bit binary in this example) serves for automatic recognition of the incoming video frame time-line position within a playout loop and automatic selection of the matching secondary reference video frame.

Four Geometry Reference Stamp 208 (in this example, four white crosses on black background) provide for automatic measurement of image geometry modifications introduced by video data processing within the Content Delivery Network (e.g. aspect ratio conversion) and automatic selection of the matching secondary reference video frame geometry.

Light Gray rectangle 212 designates the boundary of Clean Zone, containing Zone Plate Sprite 214 moving along the elliptic trajectory 216.

Current Stress Level Indicator 218 serves as a visual guide; it is not used for any automatic calculations.

Stress Zone 220 contains pseudo-random YUV texture, which stepwise increases its contrast along the time-line, and its right boundary 222 expands rightwards along the time-line.

Stress Zone 224 contains another (uncorrelated) pseudo-random YUV texture, which also increases its contrast and its left boundary 226 expands leftwards along the time-line.

It should be noted, that encoding of stress zones textures requires significant encoder resources, which may result in the significant distortion of all test pattern components, including those situated in the Clean Zone, in particular the distortion of the Zone Plate Sprite 214. Analysis of Zone Plate spectrum provides valuable additional information about the quantization scales controls and buffer occupancy controls chosen by the encoder in response to the stress.

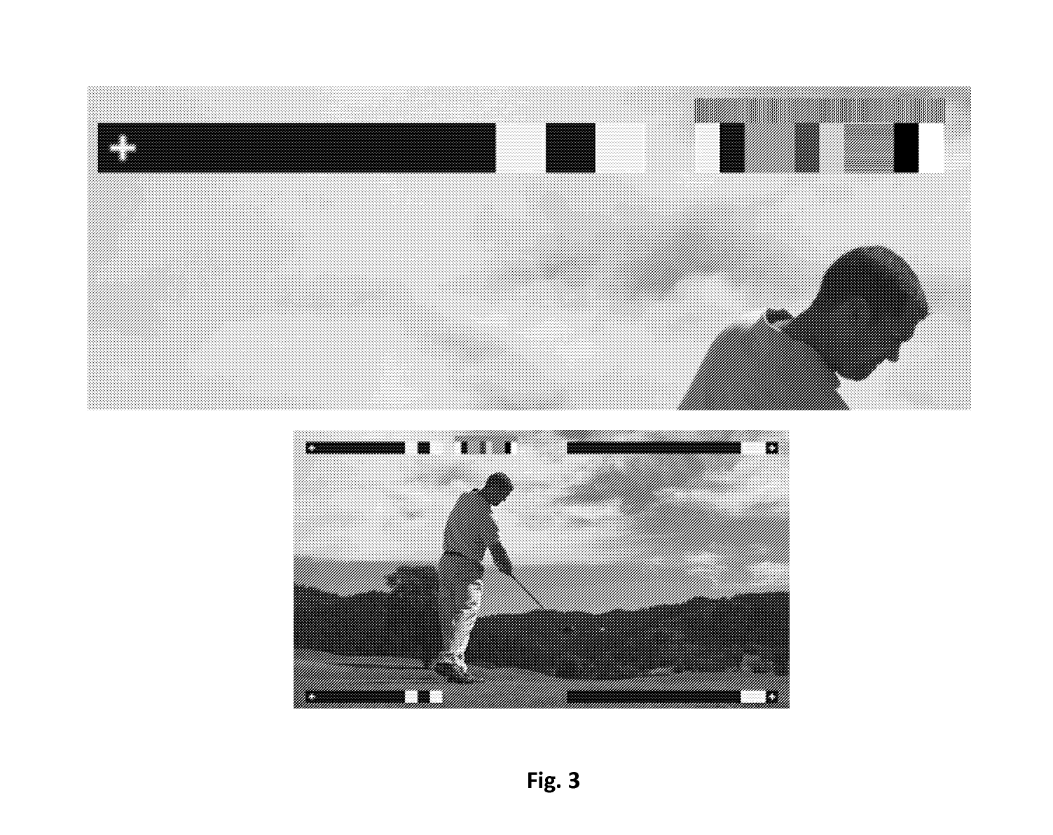

FIG. 3 shows example of “Golfer” Live Clip with Stamps.

Stamps shown are similar to those described for FIG. 2, but this test is not subdivided in zones. This example illustrates that Stamps can be used in combination with traditional compression artefacts estimation methodology based on live clips. Main advantage of this test vs. traditional tests, not containing stamps, is its suitability to work even after image geometry modification, frame size and/or color space modifications.

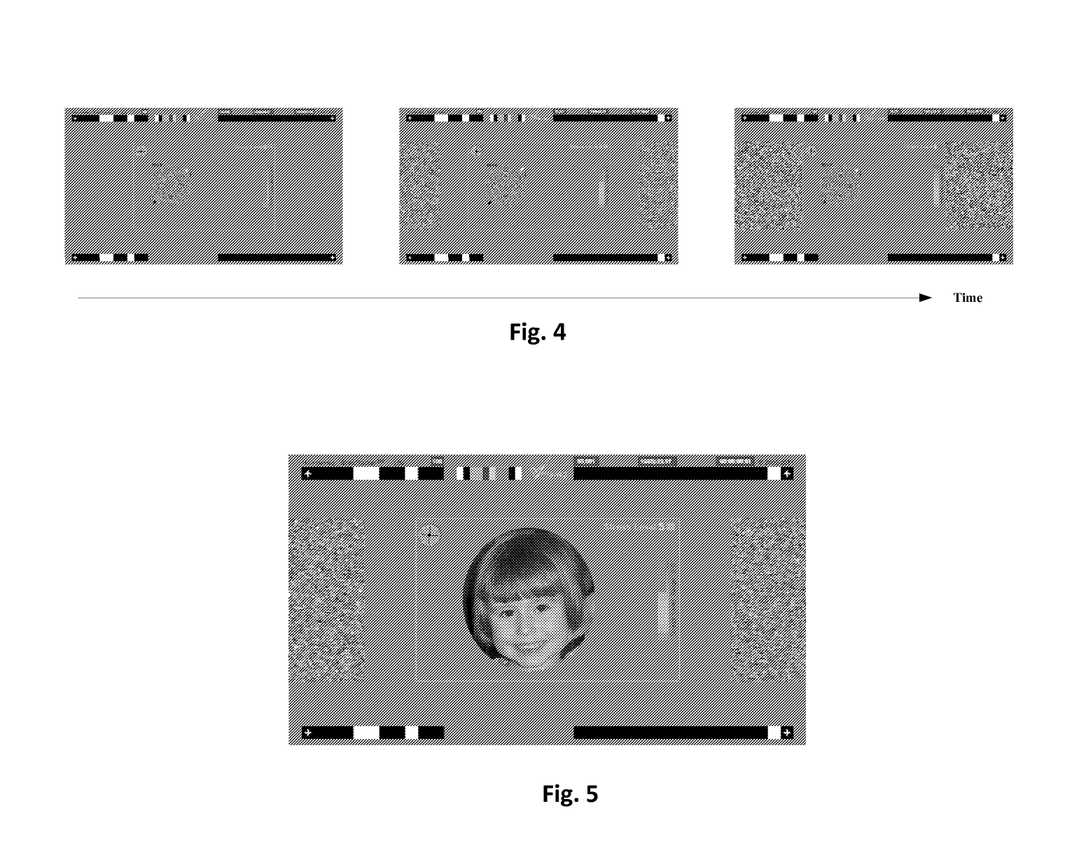

FIG. 4 shows example of Stress Tracker Test Sequence Timeline.

Size and contrast of Stress Zone textures increment in several steps along the time-line from zero to maximum.

In the example shown it means ten steps, i.e. ten different levels of stress.

Total duration of video loop is typically set between 50 and 100 seconds, allowing enough time for the encoder to optimize its behavior during each of ten steps.

FIG. 5 shows variant of Stress Tracker Test with Static Picture in the Clean Zone.

The advantage of this variant vs. Zone Plate variant, shown on FIG. 2, is larger number of colors in the palette and less demanding distribution of spatial frequencies.

Another advantage of this variant is that the static central part can be captured off LCD screen by any still camera or video camera without the need for frame rate synchronization.

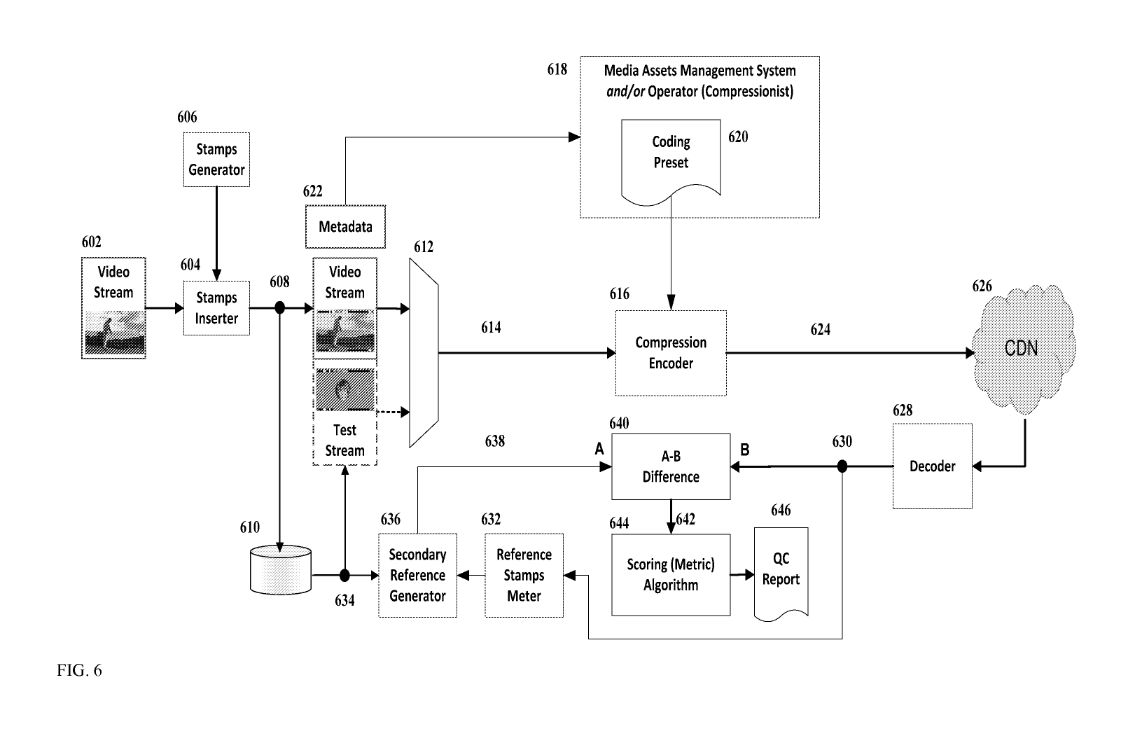

FIG. 6 shows the block diagram of one embodiment of the Video Compression Quality Meter system block diagram.

The embodiment of FIG. 6 is particularly advantageous in digital video distribution systems, especially to the hardware and software systems and devices used for multi-format content production, post-production, re-purposing and delivery. It is particularly efficient with application to Content Delivery Networks (CDN).

Referring now to FIG. 6, input live video 602 is converted by Stamp Inserter 604, driven by Stamp Generator 606, into stamped video data 608.

These data are captured for further use in local storage device 610 and also fed to the input selector 612. Selector 612 allows optional replacement of the incoming live video by pre-captured version of the video stream in question, or by a locally stored test pattern or by another video clip available in the storage 610.

From selector 612 primary reference video data stream 614 goes into compression encoder 616, controlled by Media Assets Management System 618 and/or Operator (Compressionist), providing a coding preset 620 based among other factors on the incoming metadata 622.

Compressed video stream 624 via Content Delivery Network 626 comes to the reference decoder 628. Decompressed video 630 is not necessarily suitable for comparison with the primary reference video 614, for example because of the different frame sizes.

Stamps, contained in video stream 630 are measured/decoded in the Reference Stamp Meter 632, which controls the Secondary Reference Generator 636.

This important block converts a stored copy 634 of primary reference video, replayed from storage 610, into Secondary Reference Video 638, suitable for comparison with decoded video 630.

If necessary, the Secondary Reference Generator 636 can apply (online or offline) spatial scaling (including image geometry modification), color correction and color space conversion. It is also capable of finding in the storage 610 a video frame with pattern ID and time-line position matching those of the current frame of video stream 630.

Block 640 performs calculation of differential (“A-B”) video stream 642, which represents compression artefacts (errors), in the format matching the format of the delivered images at the CDN 626 output.

Differential stream 642 goes into the block 644, which calculates compression quality estimate (quality score) in accordance to some commonly accepted algorithm (metric).

The result is Quality Report 646 document (set of compression quality scores).

Unlike prior art system, the system of FIG. 6 can measure compression artefacts and other distortions in much wider range of conditions—with different frame sizes and even in presence of short-term skips/freezes of the delivered video stream.

Because the reference stamps are mainly static and occupy only a small fraction of total image area, their presence does not significantly affect the payload of compression codec.

Thus, the quality measurements are not significantly biased by the presence of the stamps.

The secondary reference video sequence may be created in advance and stored within the video quality analyzer or created on-the-fly in parallel with the process of delivered content capture, once the parameters of input content package are known.

It is desirable, so not absolutely necessary, that the secondary reference video sequence contains reference stamps identical to those inserted into incoming video.

If present, stamp areas are used in the quality measurement the same way as other image areas, i.e. in absence of significant errors they are not visible in the differential images.

Correct operation of video quality analyzer depends on its capability to retrieve or create appropriate secondary reference video stream.

It should be noted that retrieval or generation of down-converted secondary reference video (co-timed, scaled and color-corrected version of the primary reference video) usually requires only a fraction of the available resources.

However, the system may work even without the inserted stamps. In such case manual scaling, time offset and color corrections controls may replace automatic controls, though it may require much more time and video quality measurement accuracy may suffer.

What is claimed is:

1. A method for testing video quality, comprising:
generating a stress tracker test pattern with one or more moving zone plates and one or more stamps;
determining compression quality scores for encoder resources spent at predetermined levels of compression (stress); and
analyzing the test pattern and generating a Compression Stress Response profile.

2. The method of claim 1, comprising applying the profile for benchmarking, acceptance tests or comparison of encoding presets.

3. The method of claim 1, comprising generating the test pattern with a flat gray background, at least one Clean Zone, at least one Stress Zone and at least one set of Reference Stamps.

4. The method of claim 1, comprising repeating all stamps of the set for noise immunity.

5. The method of claim 1, comprising repeating all stamps of the set at a top and a bottom of the image.

6. The method of claim 1, comprising automatically recognizing an incoming video identification and automatically selecting a matching secondary reference data.

7. The method of claim 1, comprising representing a pattern code stamp in binary format corresponding to an identification code of the pattern.

8. The method of claim 1, comprising performing automatic detection and measurement of color space modifications introduced by video data processing within a Content Delivery Network.

9. The method of claim 1, comprising generating a Color Reference Stamp with shades of Gray and calibrated Color patches.

10. The method of claim 1, comprising generating a Frequency Reference Stamp in form of digital burst with a high frequency.

11. The method of claim 1, comprising automatically recognizing incoming video frame time-line position within a play-out loop and automatically selecting a matching secondary reference video frame.

12. The method of claim 1, comprising generating a Geometry Reference Stamp for automatic measurement of image geometry modifications introduced by video data processing within a Content Delivery Network.

13. The method of claim 12, wherein the Geometry Reference Stamp comprises four white crosses on a black background.

14. The method of claim 12, comprising automatically selecting matching secondary reference video frame geometry.

15. The method of claim 1, comprising generating a rectangle designating a Clean Zone boundary.

16. The method of claim 1, comprising generating a current Stress Level Indicator as a visual guide.

17. The method of claim 1, comprising generating a Stress Zone with a pseudo-random YUV texture with stepwise increased contrast along a time-line, and a right boundary expanding rightwards along the time-line.

18. The method of claim 17, wherein the Stress Zone contains another uncorrelated pseudo-random YUV texture with a left boundary expanding leftwards along the time-line.

19. A system to perform automated analysis of video quality of a video processor or a content delivery system, comprising
means for inserting reference stamps into original video images a set of pre-defined area stamps, including predefined content code (clip number) stamp, time-code stamps, spatial position (geometry) stamps, and color space stamps to create a primary reference video sequence;
means for automatic input video format detection and conversion of delivered video data into uncompressed format;
means for automatic measurements of parameters of all stamps contained within the delivered images;
means for creation or retrieval of secondary reference video sequence matching delivered video images in size, spatial position, aspect ratio, time-line position and color space;
means for determining error image and generating a difference between delivered video sequence and secondary reference sequence; and
means for converting the differential images into objective statistical values.

20. The system of claim 19, comprising:
a. means for determining the statistical values separately for stress zone and clean zone, and separately for each stress level;
b. means for creating measured stress response time profile; and
c. means for conversion of said objective statistical values into reported objective score values correlated with traditional subjective image quality scores.
